(19) United States
(12) Patent Application Publication
(10) Pub. No.: US 2015/0106304 A1
(43) Pub. Date: Apr. 16, 2015

(54) Identifying Purchase Intent in Social Posts

(71) Applicant: Adobe Systems Incorporated, San Jose, CA (US)

(72) Inventors: Vineet Gupta, Kanpur (IN); Harsh Jhamtani, Kanpur (IN); Devesh Varshney, Roorkee (IN); Deepam Kedia, Ahmedabad (IN); Shweta M. Karwa, Jalna (IN)

(73) Assignee: Adobe Systems Incorporated, San Jose, CA (US)

(21) Appl. No.: 14/054,238

(22) Filed: Oct. 15, 2013

(51) Int. Cl. G06N 5/04; G06N 99/00

(52) U.S. Cl. CPC G06N 5/04; G06N 99/005
USPC 706/11; 706/45; 706/52; 706/12

(57) ABSTRACT

This document describes techniques for identifying purchase intent in social posts. In one or more implementations, a topic is received and social posts to one or more social networks that are related to the topic are collected. Then, one or more purchase intent posts expressing purchase intent towards the topic are identified from the collected social posts. In one or more implementations a purchase intent model, usable to identify social posts expressing purchase intent, is built from a training corpus of annotated social posts.

### BACKGROUND

There are a vast number of social conversations occurring on social networks at any given time. One important topic that users discuss on social networks is what they need or want. For instance, a user may say “I'm hungry”, which means that the user wants something to eat. As another example, a user may say “I need a new phone”, which means that the user wants to purchase a phone. Being able to track social network conversations is very valuable to businesses because if a business knows what a user needs, the business can effectively target campaigns and advertisements to the user.

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

### SUMMARY

This document describes techniques for identifying purchase intent in social posts. In one or more implementations, a topic is received and social posts to one or more social networks that are related to the topic are collected. Then, one or more purchase intent posts expressing purchase intent towards the topic are identified from the collected social posts. In one or more implementations a purchase intent model, usable to identify social posts expressing purchase intent, is built from a training corpus of annotated social posts.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different instances in the description and the figures indicate similar or identical items.

FIG. 1 illustrates an environment in an example implementation that is operable to employ techniques described herein.

FIG. 2 illustrates a system in an example implementation in which a purchase intent model is used to identify social posts expressing purchase intent towards a given topic.

FIG. 3 illustrates an example user interface in accordance with one or more implementations.

FIG. 4 illustrates an additional example user interface in accordance with one or more implementations.

FIG. 5 illustrates a procedure in an example implementation in which a purchase intent model is used to identify social posts expressing purchase intent towards a given topic.

FIG. 6 illustrates a procedure in an example implementation in which a purchase intent model is built.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

### Overview

This document describes techniques for identifying purchase intent in social posts. In one or more implementations, a topic is received and social posts to one or more social networks that are related to the topic are collected. Then, one or more purchase intent posts expressing purchase intent towards the topic are identified from the collected social posts. In one or more implementations a purchase intent model, usable to identify social posts expressing purchase intent, is built from a training corpus of annotated social posts.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

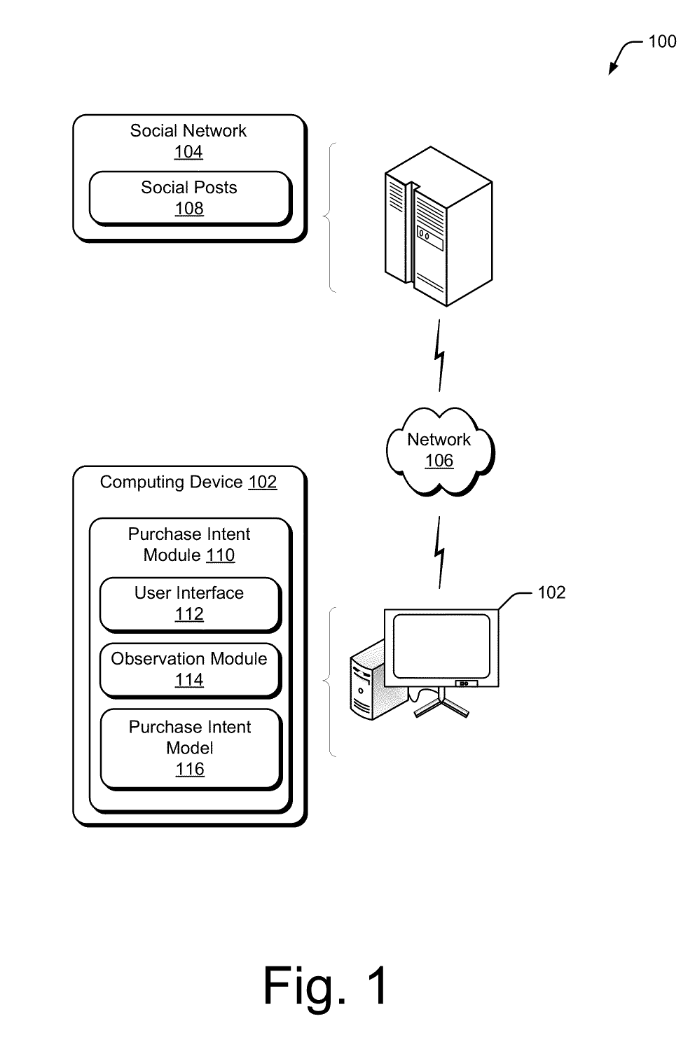

FIG. 1 illustrates an environment 100 in an example implementation that is operable to employ techniques described herein. Environment 100 includes a computing device 102 and a social network 104 that are communicatively coupled via a network 106. Computing device 102 and social network 104 may be configured in a variety of different ways.

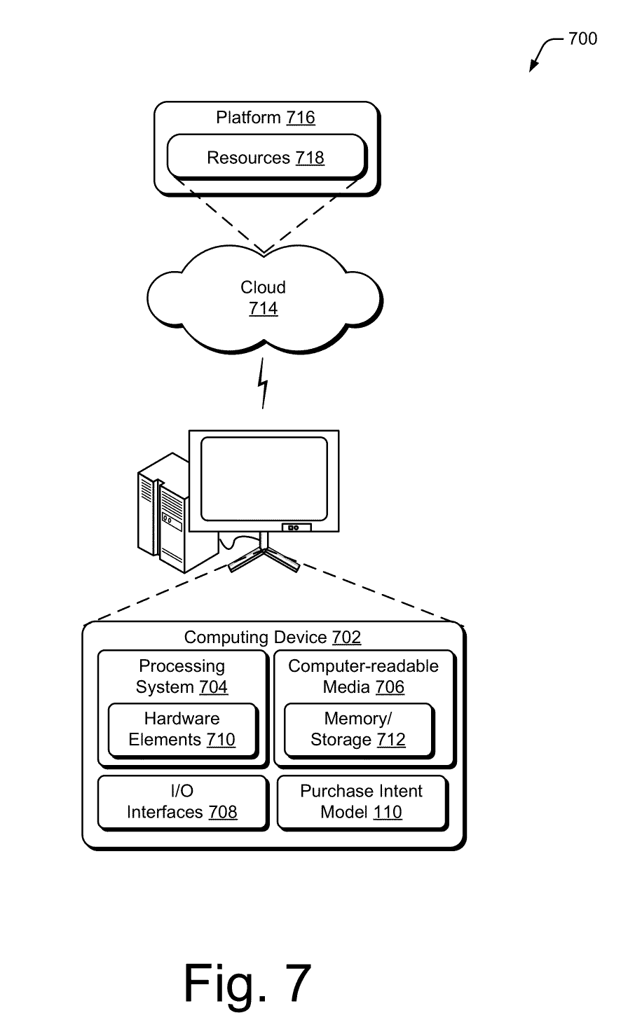

Computing device 102, for instance, may be configured as a desktop computer, a laptop computer, a mobile device (e.g., assuming a handheld configuration such as a tablet or mobile phone), and so forth. Thus, computing device 102 may range from full resource devices with substantial memory and processor resources (e.g., personal computers, game consoles) to a low-resource device with limited memory and/or processing resources (e.g., mobile devices). Additionally, although a single computing device 102 is shown, computing device 102 may be representative of a plurality of different devices, such as multiple servers utilized by a business to perform operations “over the cloud” as further described in relation to FIG. 7.

Although network 106 is illustrated as the Internet, the network may assume a wide variety of configurations. For example, network 106 may include a wide area network (WAN), a local area network (LAN), a wireless network, a public telephone network, an intranet, and so on. Further, although a single network 106 is shown, network 106 may also be configured to include multiple networks.

Social network 104 provides an interface (not shown) for multiple users to interact with a social network community over network 106. As described herein, a social network may include blogs and online forums, social media sharing services, social networking services, and social news services.

Social media sharing services can include video services (e.g., YouTube® and Vimeo®), photo services (e.g., Flickr®, Picasa®, and Instagram®), audio services (e.g., Pandora® and LastFM®), and bookmark services (e.g., StumbleUpon® and Delicious®). Example of social networking services include Facebook®, Google+®, Twitter®, LinkedIn®, Plurk®, and Xing®. Examples of social news services include Digg® and Reddit®.

Social network 104 enables users to submit social posts 108 to the social network. As described herein, social posts 108 include any message published to an online forum or newsgroup, a social network platform (e.g., Facebook®, Twitter®, or Instagram®), a blog, or any other type of social network 104. In some cases, social posts 108 may also include responses, comments, or replies to an original social post 108 by users of the social network community.

Computing device 102 is illustrated as including a purchase intent module 110 which is configured to identify social posts 108 that express purchase intent towards a given topic. Purchase intent module 110 includes a user interface 112, an observation module 114, and a purchase intent model 116. User interface 112 is configured to receive user input that identifies a topic. As described herein, a topic can include any category of goods or services that can be purchased or consumed by users, such as travel, food, phones, or cars, to name just a few. A topic can also be directed to specific brands or items, such as iPhone®, Toyota® Camry, Nike®, or Red Robin®.

Observation module 114 monitors one or more social networks 104 to collect social posts 108 that are related to the identified topic. Purchase intent module 110 then provides the identified topic and the collected social posts to purchase intent model 116. Purchase intent model 116 is configured to identify, from the collected social posts, one or more social posts 108 that express purchase intent towards the identified topic. As described herein, social posts 108 that express purchase intent towards a given topic will be referred to as purchase intent posts (PI posts), and social posts 108 that do not express purchase intent towards the given topic will be referred to as non-purchase intent posts (non-PI posts).

As described herein, expressing purchase intent towards a topic means that the social post includes words that indicate an intent to purchase the topic (e.g., a product or service). In some cases, PI posts include social posts 108 in which a user indicates a desire or need for a particular product, and/or an intent to purchase the particular product in the near future. The term near future can correspond to any period of time. For example, in some cases the near future may correspond to a few hours, such as in the case in which a user posts “what is the best place to eat in Seattle tonight”. In other cases, the near future may correspond to a few days, a week, or a month, such as in the cases in which a user posts “I want to buy a new phone”. In other cases, the near future may even correspond to a year, such as in the case in which a user posts “I am traveling to Hawaii next year, which hotel should I stay in?”

Unlike PI posts, non-PI posts include social posts 108 which do not express intent to purchase the product in the near future. Non-PI posts, however, may express a user's positive or negative sentiment towards a product without expressing an intent to purchase the product, such as in the case in which a user posts “I love my new phone”.

Although illustrated as part of computing device 102, functionality represented by purchase intent module 110 may be further divided, such as to be performed “over the cloud” by one or more servers that are accessible via network 106, further discussion of which may be found in relation to FIG. 7.

Using the Purchase Intent Model to Identify Purchase Intent in Social Posts

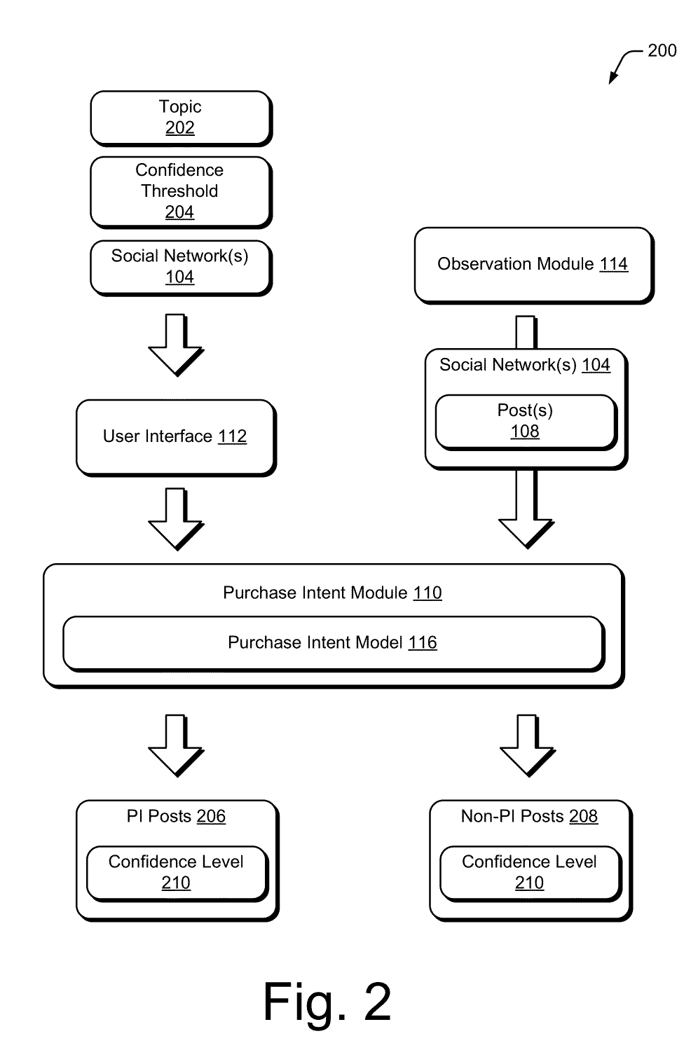

FIG. 2 illustrates a system 200 in an example implementation in which purchase intent model 116 is used to identify social posts 108 that express purchase intent towards a given topic

In this example, user input that identifies a topic 202, a confidence threshold 204, and one or more social networks 104 is received via user interface 112. In one or more embodiments, confidence threshold 204 can be selected to be between 1 and 100, and enables the user to specify the level of confidence required for a social post 108 to be classified as a PI post by purchase intent model 116.

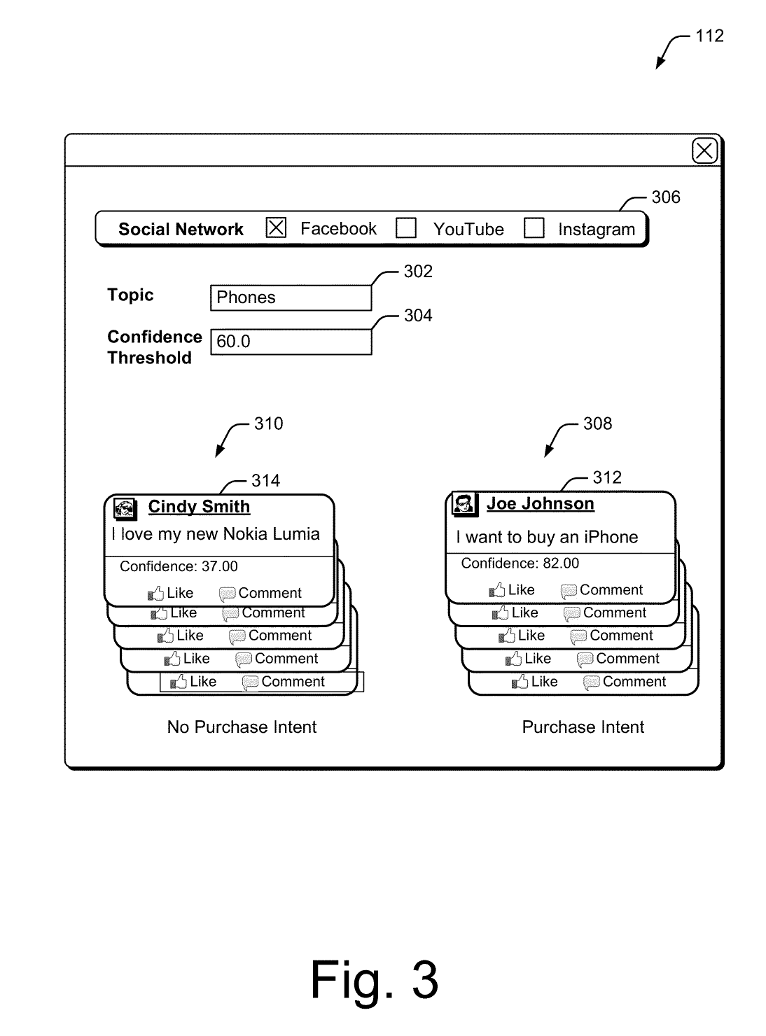

As an example, consider FIG. 3 which illustrates an example of user interface 112. In this example, user interface 112 includes a topic control 302 that enables a user to identify a particular topic, a confidence threshold control 304 which enables the user to specify the confidence threshold, and a social network control 306 which enables the user to select which social networks are to be monitored. In FIG. 3, the user has input the topic “Phones” into topic control 302, has input a confidence threshold of “60.0” into confidence threshold control 304, and has selected Facebook® from social network control 306. Note that user interface 112 enables the user to monitor a single social network 104, or multiple different social networks 104 (such as both Facebook® and Twitter®).

Returning to FIG. 2, social posts 108 to social network 104 that are related to topic 202 are collected by observation module 114. For example, observation module 114 can scan the text of social posts 108 to find social posts that include topic 202. Observation module 114 is configured to identify specific types of topic 202 in social posts 108. For example, if “phones” is input as topic 202, observation module 114 can identify specific types or brands of phones, such as “iPhone”, “Nokia Lumia”, or “Samsung Galaxy”. Observation module 114 can be configured to collect, in real time, social posts 108 that are currently being posted to social network 104 and/or social posts 108 that were previously posted to social network 104.

Purchase intent module 112 passes topic 202, confidence threshold 204, and the collected social posts 108 that are related to topic 202 to purchase intent model 116. Purchase intent model 116 then determines which of the collected social posts 108 express purchase intent towards topic 202, and classifies these posts as PI posts 206. Purchase intent model 116 classifies the remainder of the collected social posts 108 that are related to topic 202, but do not express purchase intent towards topic 202, as non-PI posts 208.

In order to determine whether a social post 108 should be classified as a PI post 206 or a non-PI post 208, purchase intent model 116 computes a confidence level 210 for each of the collected social posts 108. Confidence level 210 is a measure of the confidence of a social post 108 expressing purchase intent towards topic 202, and is computed based on various features of the social post. In some cases, the confidence level is computed to be between 1 and 100, where a confidence level of 100 indicates that purchase intent model 116 is 100% confident that the social post is a PI post 206.

In one or more embodiments, the various features of social posts that are indicative of purchase intent include whether the social post includes an object of desire that the user wishes to purchase or consume, an action verb that depicts purchase intent towards the object of desire, and/or a self-reference to a user. For example, in the example social post “I want to buy a phone”, the object of desire is “phone”, the action verb is “buy”, and the self-reference to the user is “I”. Other features of social posts that are indicative of purchase intent may include whether the social post includes a named entity, such as a place or organization, and whether the social post includes a positive sentiment word, such as “good” or “nice”. In some cases, the features indicative of purchase intent may also include “bag-of-words” based delta-term frequency-inverse document frequency (TF-IDF) vectors.

In one or more embodiments, purchase intent model 116 determines whether each social post 108 is classified as a PI post 206 or a non-PI post 208 based on a comparison of confidence level 210 to confidence threshold 204. If confidence level 210 of a social post 108 is greater than or equal to confidence threshold 204, then the social post will be classified as a PI post 206. Alternately, if confidence level 210 of a social post 108 is less than confidence threshold 204, then the social post will be classified as a non-PI post 208.

After separating PI posts 206 and non-PI posts 208, purchase intent module 110 can cause display of representations of PI posts 206 and non-PI posts 208 in user interface 112. As an example, consider again, FIG. 3. In this example, user interface 112 display representations of PI posts 308 and non-PI posts 310. Both PI posts 308 and non-PI posts 310 are related to the selected topic “Phones”. PI posts 308, however, express purchase intent to buy a phone, whereas non-PI posts 310 do not express purchase intent to buy a phone.

User interface 112 enables the user to select a representation of one of PI posts 308 or non-PI posts 310 to view additional information about the selected post. In FIG. 3, for example, a user has selected a representation of PI post 312 from PI posts 308. Responsively, user interface 112 displays an identifier of the user of selected PI post 312 (“Joe Johnson”), the text of the selected PI post 312 (“I want to buy an iPhone”), and the confidence level of the selected PI post 312 (“82.00”).

As an iPhone is a type of phone, PI post 312 has also been classified as corresponding to the selected topic of phones by purchase intent model 116. In addition, PI post 312 includes features that indicate purchase intent, which causes purchase intent model 116 to compute a confidence level of “82.00” for PI post 312. For example, PI post 312 includes an object of desire (“iPhone”), an action verb (“buy”) depicting purchase intent to buy the object of desire, and a self-reference (“I”). Note that PI post 312 is classified as a PI post 308 because the confidence level of 82.00 is greater than the confidence threshold of 60.00 set by the user.

In this example, non-PI posts 310 include a non-PI post 314 by a user “Cindy Smith” which states “I love my new Nokia Lumia”. A Nokia Lumia is a type of phone, and thus this post has been classified as corresponding to the selected topic of phones by purchase intent model 116. Additionally, non-PI post 314 includes some features that indicate purchase intent, such as an object of desire (“Nokia Lumia”) and a self-reference “I”. Non-PI Post 314 does not, however, include an action verb depicting purchase intent. As such, purchase intent model has assigned a confidence level of 37.00 to non-PI post 314. Note that non-PI post 314 is classified as a non-PI post 310 because the confidence level of 37.00 is less than the confidence threshold of 60.00 set by the user.

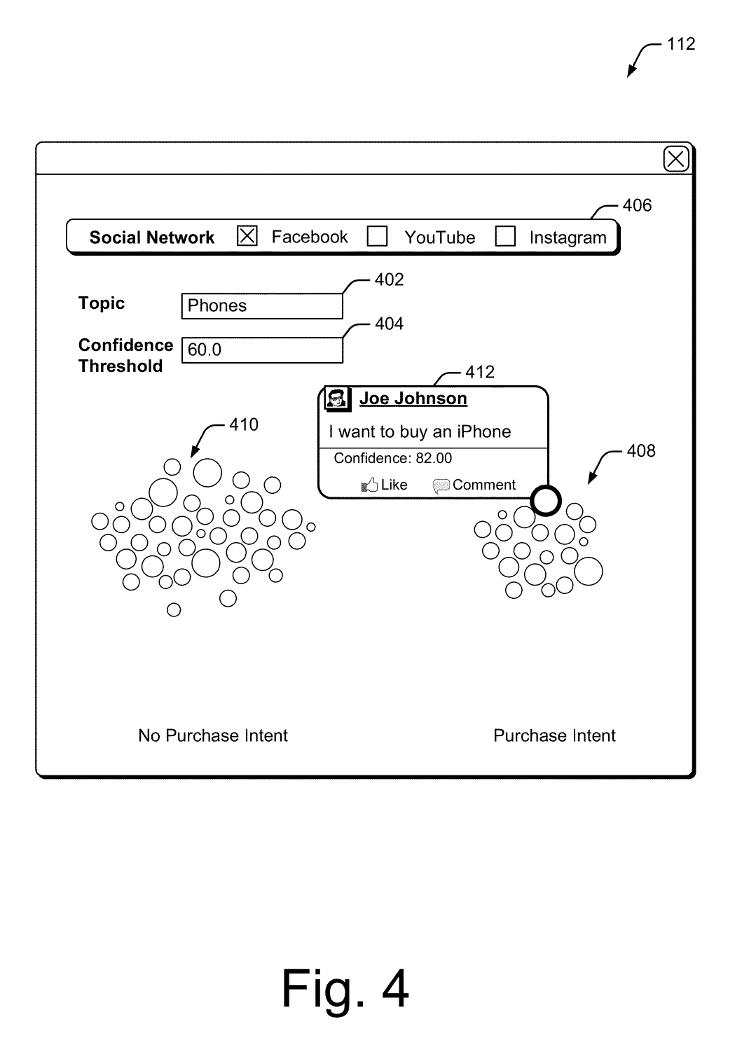

As another example of user interface 112, consider FIG. 4. Similar to FIG. 3, user interface 112 in FIG. 4 includes a topic control 402 that enables a user to identify a particular topic, a confidence threshold control 404 which enables the user to specify the confidence threshold, and a social network control 406 which enables the user to select which social networks are to be monitored. Unlike user interface 112 in FIG. 3, however, in FIG. 4 user interface 112 displays representations of PI posts 408 and non-PI posts 410 in the form of dots. Each individual dot represents a particular social post 108 that a user has made to social network 104.

In one or more embodiments, a size of the dot of PI posts 408 represents the confidence level of the particular post expressing purchase intent. For example, the larger the dot of a selected post, the higher the confidence level of the selected post.

In one or more embodiments, a user can hover over each dot to see additional information about the particular social post. In FIG. 4, for example, a user has hovered over a representation of PI post 412, and in response, user interface 112 displays additional information about PI post 412. In this example, the additional information includes an identifier of the user of selected PI post 412 (“Joe Johnson”), the text of the selected PI post 412 (“I want to buy an iPhone”), and the confidence level of the selected PI post 412 (“82.00”).

In one or more embodiments, purchase intent model 116 is configured to sort PI posts 206 based on the confidence level 210 associated with each post. In this way, purchase intent model 116 may provide the user with the social posts which purchase intent model is most confident express purchase intent. Consider, for example, that if thousands of social posts are identified that indicate purchase intent towards a given topic, that businesses may prefer to see the posts which purchase intent model 116 is most confident corresponds to purchase intent towards the given topic.

In one or more embodiments, purchase intent module 110 can automatically target advertisements to users that make PI posts 206 to social network 104. For example, a mobile phone company may be able to use purchase intent module 110 to cause an advertisement or promotion to be displayed to users that make social posts expressing purchase intent towards a phone.

Building the Purchase Intent Model

In order to build purchase intent model 116, a “training corpus” can be generated by annotating multiple social posts 108 that were previously posted to social network 104 to indicate whether the social post expresses purchase intent or does not express purchase intent.

The training corpus can then be analyzed to determine the various features of social posts 108 that are indicative of purchase intent. To do so, the text of the training corpus is linguistically parsed to located features indicative of purchase intent. Any standard machinery can be used for the linguistic parsing of the text.

The features indicative of purchase intent include purchase intent words (PI words) and non-purchase intent words (non-PI words). To determine PI words and non-PI words, the training corpus is parsed to locate verbs and nouns. The located verbs and nouns can then be scored based on how many times the located verbs and nouns occur in annotated social posts expressing purchase intent, versus how many times the located verbs and nouns occur in annotated social posts not expressing express purchase intent. For instance, if a particular verb occurs often in social posts that express purchase intent, this particular verb will be assigned a high score to indicate that the verb indicates purchase intent.

In some implementations, the following equation is used to score each word:

$$Score ( w ) = \frac{n ( {w}^{+} )}{{N}_{+}} log \frac{{N}_{-}}{n ( {w}^{-} )}$$

In this equation, the variable “w” corresponds to a word (e.g., a verb or noun) extracted from social posts of the training corpus. The variable “w⁺” corresponds to the number of times that this word appears in social posts of the training corpus that express purchase intent, and the variable “w” corresponds to the number of times that this word appears in social posts of the training corpus that do not express purchase intent. The variable “N⁺” corresponds to the total number of social posts in the training corpus that express purchase intent, and “N” corresponds to the total number of social posts in the training corpus that do not express purchase intent.

The scored verbs and nouns are then selected to be either PI words or non-PI words based on the respective score of each scored verb or noun. For example, scores above a certain threshold may qualify a word as a PI word, whereas scores below the threshold may qualify the word as a non-PI word.

The PI words and the non-PI words that are recognized by PI model 116 can then be expanded using an external database, such as Wordnet and/or Freebase. Wordnet can be used to obtain hypernyms of PI nouns that express purchase intent. For example, a tomato can be expanded to be classified as a type of food using the Wordnet database, and a car can be classified as a type of vehicle. Freebase is a structured knowledgebase of places, people, and things by Google®, and can be used to find purchase intent categories for PI nouns. For example, iPhone® can be classified as a phone or a communication device by Freebase, and a Macbook® Pro can be classified as a computer by Freebase.

In some cases, the features indicative of purchase intent may also include “bag-of-words” based delta-TF-IDF vectors. To calculate the delta-TF-IDF vectors, PI posts and non-PI posts are separated from the annotated social posts. Then, for each word occurring in these two sets of data, a higher delta-TF-IDF score is given to words that occur in a PI post and a lower delta-TF-IDF score is given to words that occur in a non-PI post. The delta-TF-IDF vector score is computed using the following formula:

$${V}_{t , p} = {n}_{t , p} * {log}_{2} ( \frac{{N}_{t}}{{P}_{t}} )$$

In this formula, n_{t,p} corresponds to the frequency count of a term t in a post p, Pₜ corresponds to the number of posts of the annotated PI posts with the term t, and Nₜ corresponds to the number of posts of the annotated non-PI posts with the term t. Thus, purchase intent model 116 can be more confident that a social post 108 corresponds to a PI post if the social post includes words with high delta-TF-IDF vector scores.

The features indicative of purchase intent may further include whether a social post includes an object of desire that the user wishes to purchase or consume, an action verb that depicts purchase intent towards the object of desire, and/or a self-reference to a user. Other features of social posts that are indicative of purchase intent may include whether the social post includes a named entity, such as a place or organization, and/or whether the social post includes a positive sentiment word, such as “good” or “nice”.

Purchase intent model 116 can then be built by passing the features indicative of purchase intent to a machine-learning model to model social posts that have purchase intent as opposed to posts that do not have purchase intent. Examples of machine-learning models include “Random-Forest Classification” and “SVM-Linear Kernel Classification”, to name just a few.

Example Procedures

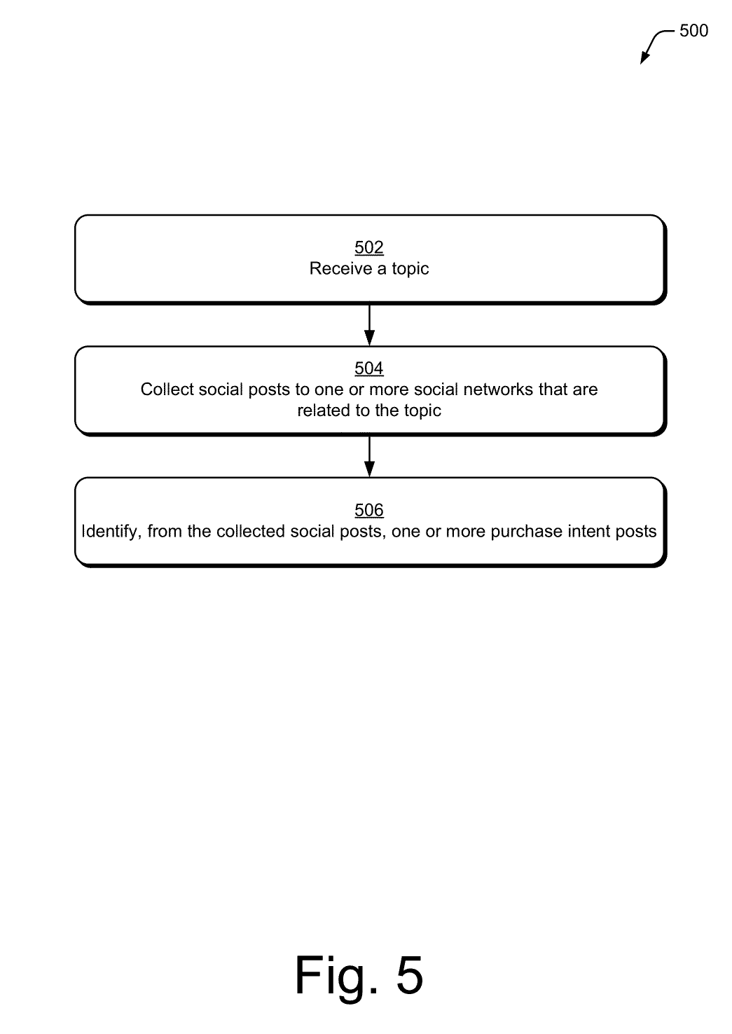

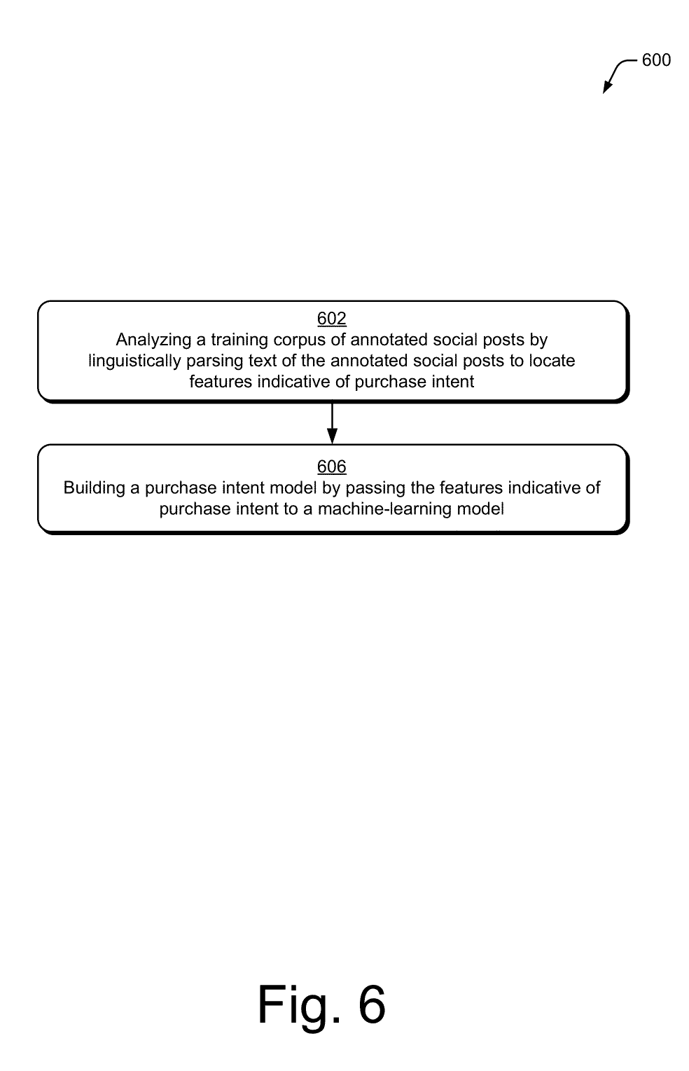

The following discussion describes techniques for identifying social posts expressing purchase intent towards a given topic (FIG. 5) and for building a purchase intent model (FIG. 6) that may be implemented utilizing the systems and devices described herein. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

FIG. 5 illustrates a procedure 500 in an example implementation in which a purchase intent model is used to identify purchase intent in social posts.

At 502, a topic is received. For example, user interface 112 (FIG. 1) receives a topic via topic control 302 (FIG. 3).

At 504, social posts to one or more social networks that are related to the topic are collected. For example, observation module 114 collects social posts 108 to one or more social networks 104 that are related to the topic.

At 506, one or more purchase intent posts are identified from the collected social posts. For example, purchase intent model 116 identifies one or more purchase intent posts from the collected social posts. The one or more purchase intent posts each express purchase intent towards the topic.

FIG. 6 illustrates a procedure 600 in an example implementation in which a purchase intent model is built.

At 602, a training corpus of annotated social posts is analyzed by linguistically parsing text of the social posts to locate features indicative of purchase intent. Any standard machinery can be used for the linguistic parsing of the text. In one or more embodiments, the features indicative of purchase intent include PI words and non-PI words. To determine PI words and non-PI words, the training corpus is parsed to locate verbs and nouns. The located verbs and nouns can then be scored based on a comparison of a number of times that the located verbs and nouns occur in annotated social posts expressing purchase intent and a number of times that the located verbs and nouns occur in annotated social posts not expressing purchase intent. For instance, if a particular verb occurs often in posts that express purchase intent, this particular verb will be assigned a high score to indicate that the verb indicates purchase intent.

The features indicative of purchase intent may further include whether a social post includes an object of desire that the user wishes to purchase or consume, an action verb that depicts purchase intent towards the object of desire, and/or a self-reference to a user. Other features of social posts that are indicative of purchase intent may include whether the social post includes a named entity, such as a place or organization, and whether the social post includes a positive sentiment word, such as “good” or “nice”. In some cases, the features indicative of purchase intent may also include “bag-of-words” based delta-TF-IDF vectors.

At 604, a purchase intent model is built by passing the features indicative of purchase intent to a machine-learning model. For example, purchase intent model 116 is built by passing the scored verbs and nouns to a machine-learning model

Having described example procedures in accordance with one or more implementations, consider now an example system and device that can be utilized to implement the various techniques described herein.

Example System and Device

FIG. 7 illustrates an example system generally at 700 that includes an example computing device 702 that is representative of one or more computing systems and/or devices that may implement the various techniques described herein. This is illustrated through inclusion of purchase intent module 110, which operates as described above. The computing device 702 may be, for example, a server of a service provider, a device associated with a client (e.g., a client device), an on-chip system, and/or any other suitable computing device or computing system.

The example computing device 702 is illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device implementation, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
receiving a topic;
collecting social posts to one or more social networks that are related to the topic; and
identifying, from the collected social posts, one or more purchase intent posts, the purchase intent posts expressing purchase intent towards the topic.

2. The computer-implemented method of claim 1, wherein the identifying the one or more purchase intent posts comprises computing a confidence level for each of the collected posts, and identifying the one or more purchase intent posts based on the confidence level.

3. The computer-implemented method of claim 2, further comprising sorting the collected posts based on the confidence level of each post.

4. The computer-implemented of claim 2, where the identifying further includes identifying the one or more purchase intent posts based on the confidence level of the one or more purchase intent posts exceeding a confidence threshold.

5. The computer-implemented method of claim 2, wherein the confidence level is computed by analyzing the collected posts to determine whether each post includes features indicative of purchase intent.

6. The computer-implemented method of claim 5, wherein the features indicative of purchase intent include one or more of an object of desire related to the topic, an action verb depicting purchase intent towards the object of desire, or a self-reference to a user.

7. The computer-implemented method of claim 5, wherein the features indicative of purchase intent further include one or more of a named entity or a positive sentiment word.

8. The computer-implemented method of claim 1, further comprising:
separating the one or more purchase intent posts from one or more non-purchase intent posts; and
causing display of representations of the one or more purchase intent posts and the one or more non-purchase intent posts in a user interface.

9. The computer-implemented method of claim 8, wherein the separating and causing display is performed in real-time as the social posts are being posted to the one or more social networks.

10. A computer-implemented method for building a purchase intent model comprising:
analyzing a training corpus of annotated social posts by linguistically parsing text of the annotated social posts to locate features indicative of purchase intent; and
building the purchase intent model by passing the features indicative of purchase intent to a machine-learning model.

11. The computer-implemented method of claim 10, wherein the features indicative of purchase intent include one or more of an object of desire, an action verb depicting purchase intent towards the object of desire, a self-reference to a user, a named entity, a positive sentiment word, or bag-of-words based delta-term frequency-inverse document frequency (TF-IDF) vectors.

12. The computer-implemented method of claim 10, wherein the features indicative of purchase intent include purchase intent words (PI words) and non-purchase intent words (non-PI words).

13. The computer-implemented method of claim 12, wherein the PI words and the non-PI words are determined by:
parsing the text of the annotated social posts to locate verbs and nouns; and
scoring the located verbs and nouns based on a comparison of a number of times that the located verbs and nouns occur in annotated social posts expressing purchase intent and a number of times that the located verbs and nouns occur in annotated social posts not expressing purchase intent.

14. The computer-implemented method of claim 12, further comprising expanding a number of PI words and non-PI words recognized by the purchase intent model using one or more external databases.

15. The computer-implemented method of claim 14, wherein the one or more external databases comprise at least one of Wordnet or Freebase.

16. One or more computer-readable storage media comprising instructions stored thereon that, responsive to execution by a computing device, cause the computing device to perform operations comprising:
receiving a topic;
collecting social posts to one or more social networks that are related to the topic; and
identifying, from the collected social posts, one or more purchase intent posts, the purchase intent posts expressing purchase intent towards the topic.

17. The one or more computer-readable storage media of claim 16, wherein the identifying the one or more purchase intent posts comprises:
computing a confidence level for each of the collected posts; and
identifying the one or more purchase intent posts based on the confidence level of the one or more purchase intent posts exceeding a confidence threshold.

18. The one or more computer-readable storage media of claim 17, wherein the confidence level is computed by analyzing the collected posts to determine whether each post includes features indicative of purchase intent.

19. The one or more computer-readable storage media of claim 18, wherein the features indicative of purchase intent include one or more of an object of desire related to the topic, an action verb depicting purchase intent towards the object of desire, a self-reference to a user, a named entity, or a positive sentiment word.

20. The one or more computer-readable storage media of claim 16, wherein the instructions, responsive to execution by the computing device, cause the computing device to perform operations further comprising:
separating the one or more purchase intent posts and one or more non-purchase intent posts; and
causing display of representations of the one or more purchase intent posts and the one or more non-purchase intent posts in a user interface.
